(19) United States
(12) Patent Application Publication
(10) Pub. No.: US 2009/0302930 A1
(43) Pub. Date: Dec. 10, 2009

(54) Charge Pump with Vt Cancellation Through Parallel Structure

(76) Inventors: Feng Pan, Fremont, CA (US); Jonathan H. Huynh, San Jose, CA (US)

Correspondence Address: DAVIS WRIGHT TREMAINE LLP - SANDISK CORPORATION, 505 MONTGOMERY STREET, SUITE 800, SAN FRANCISCO, CA, 94111, US

(21) Appl. No.: 12/135,945

(22) Filed: Jun. 9, 2008

(51) Int. Cl. G05F 3/02

(52) U.S. Cl. 327/536

(57) ABSTRACT

A charge pump circuit for generating an output voltage is described. The charge pump includes an output generation section and a threshold voltage cancelation section, where these sections have the same structure including a first branch, which receives a first clock signal and provides a first output, and a second branch, which receives a second clock signal and provides a second output. The charge pump circuit also includes first and second transistors, where the first and second outputs of the output generation stage are respectively connected through the first and second transistors to provide the output voltage of the charge pump, and where the first and second outputs of the threshold voltage cancellation stage are respectively connected to the control gate the first and second transistors.

### FIELD OF THE INVENTION

This invention pertains generally to the field of charge pumps and more particularly to techniques for cancelling threshold voltages of diodes in the pump.

### BACKGROUND

Charge pumps use a switching process to provide a DC output voltage larger or lower than its DC input voltage. In general, a charge pump will have a capacitor coupled to switches between an input and an output. During one clock half cycle, the charging half cycle, the capacitor couples in parallel to the input so as to charge up to the input voltage. During a second clock cycle, the transfer half cycle, the charged capacitor couples in series with the input voltage so as to provide an output voltage twice the level of the input voltage. This process is illustrated in FIGS. 1a and 1b. In FIG. 1a, the capacitor 5 is arranged in parallel with the input voltage VIN to illustrate the charging half cycle. In FIG. 1b, the charged capacitor 5 is arranged in series with the input voltage to illustrate the transfer half cycle. As seen in FIG. 1b, the positive terminal of the charged capacitor 5 will thus be 2*V_{IN} with respect to ground.

Charge pumps are used in many contexts. For example, they are used as peripheral circuits on flash and other non-volatile memories to generate many of the needed operating voltages, such as programming or erase voltages, from a lower power supply voltage. A number of charge pump designs, such as conventional Dickson-type pumps, are know in the art. But given the common reliance upon charge pumps, there is an on going need for improvements in pump design, particularly with respect to trying to reduce the amount of layout area and the efficiency of pumps.

### SUMMARY OF THE INVENTION

A charge pump circuit for generating an output voltage is described. The charge pump includes an output generation section and a threshold voltage cancelation section, where these sections have the same structure including a first branch, which receives a first clock signal and provides a first output, and a second branch, which receives a second clock signal and provides a second output. The first and second clock signals are non-overlapping. The charge pump circuit also includes first and second transistors, where the first and second outputs of the output generation stage are respectively connected through the first and second transistors to provide the output voltage of the charge pump, and where the first and second outputs of the threshold voltage cancellation stage are respectively connected to the control gate the first and second transistors.

Various aspects, advantages, features and embodiments of the present invention are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

The various aspects and features of the present invention may be better understood by examining the following figures, in which:

FIG. 1a is a simplified circuit diagram of the charging half cycle in a generic charge pump.

FIG. 1b is a simplified circuit diagram of the transfer half cycle in a generic charge pump.

FIG. 2 is a top-level block diagram for a regulated charge pump.

FIGS. 3A and 3B show a 2 stage, 2 branch version of a conventional Dickson type charge pump and corresponding clock signals.

FIGS. 4A and 4B show an exemplary embodiment based on a voltage doubler-type of charge pump.

FIG. 5 shows a comparison of the output I-V curve for the exemplary embodiment versus a conventional pump design.

FIG. 6 shows a comparison of the output (Iout/Iin) versus Vout curve for the exemplary embodiment versus a conventional pump design.

FIG. 7 shows a comparison of the output (Iout/area) versus Vout curve for the exemplary embodiment versus a conventional pump design.

### DETAILED DESCRIPTION

The techniques presented here are widely applicable to various charge pump designs for the use of cancelling the threshold voltages of the switches (typically implemented as diodes in the prior art) used to prevent the backflow of charge after pump stages. In the following, the description will primarily be based on an exemplary embodiment using a voltage doubler-type of circuit, but the concepts can also be applied to other pump designs.

More information on prior art charge pumps, such Dickson type pumps and charge pumps generally, can be found, for example, in “Charge Pump Circuit Design” by Pan and Samaddar, McGraw-Hill, 2006, or “Charge Pumps: An Overview”, Pylarinos and Rogers, Department of Electrical and Computer Engineering University of Toronto, available on the webpage “www.eecg.toronto.edu/˜kphang/ece1371/chargepumps.pdf”. Further information on various other charge pump aspects and designs can be found in U.S. Pat. Nos. 5,436,587; 6,370,075; 6,556,465; 6,760,262; 6,922,096; and 7,135,910; and applications Ser. No. 10/842,910 filed on May 10, 2004; Ser. No. 11/295,906 filed on Dec. 6, 2005; Ser. No. 11/303,387 filed on Dec. 16, 2005; Ser. No. 11/497,465 filed on Jul. 31, 2006; Ser. No. 11/523,875 filed on Sep. 19, 2006; Ser. Nos. 11/845,903 and 11/845,939, both filed Aug. 28, 2007; and Ser. Nos. 11/955,221 and 11/995,237, both filed on Dec. 12, 2007.

FIG. 2 is a top-level block diagram of a typical charge pump arrangement. The designs described here differ from the prior art in details of how the pump section 201. As shown in FIG. 2, the pump 201 has as inputs a clock signal and a voltage Vreg and provides an output Vout. The high (Vdd) and low (ground) connections are not explicitly shown. The voltage Vreg is provided by the regulator 203, which has as inputs a reference voltage Vref from an external voltage source and the output voltage Vout. The regulator block 203 regulates the value of Vreg such that the desired value of Vout can be obtained. The pump section 201 will typically have cross-coupled elements, such at described below for the exemplary embodiments. (A charge pump is typically taken to refer to both the pump portion 201 and the regulator 203, when a regulator is included, although in some usages “charge pump” refers to just the pump section 201.)

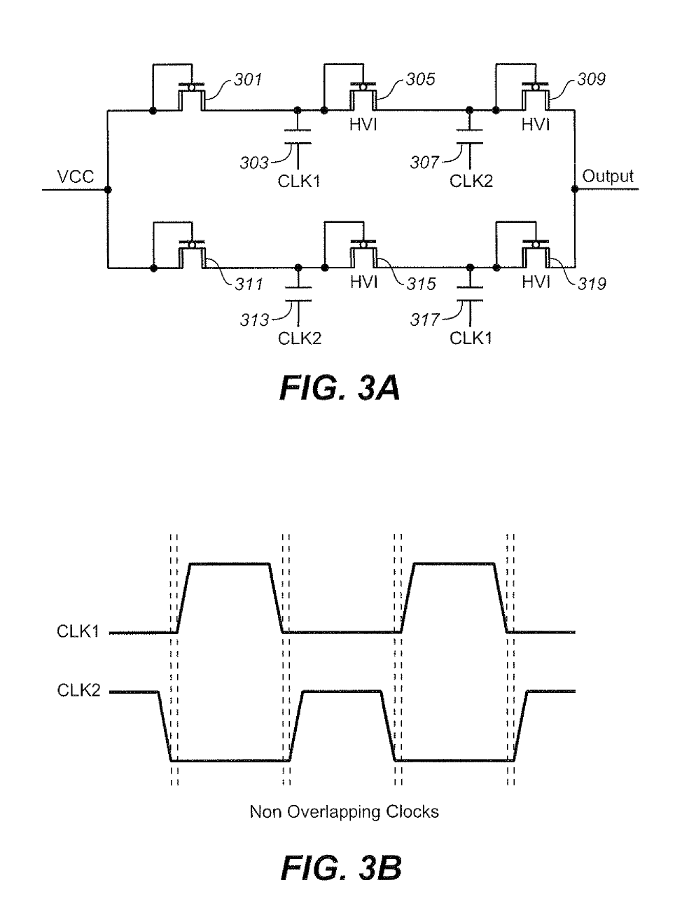

FIG. 3A shows a 2 stage, 2 branch version of a conventional Dickson type charge pump that receives Vcc as its input voltage on the left and generates from it an output voltage on the right. The top branch has a pair of capacitors 303 and 307 with top plates connected along the branch and bottom plates respectively connected to the non-overlapping clock signals CLK1 and CLK2, such as those shown in FIG. 3B. The capacitors 303 and 307 are connected between the series of transistors 301, 305, and 309, which are all diode connected to keep the charge from flowing back to the left. The bottom branch is constructed of transistors 311, 315, and 319 and capacitors 313 and 317 arranged in the same manner as the top branch, but with the clocks reversed so the tow branches will alternately drive the output.

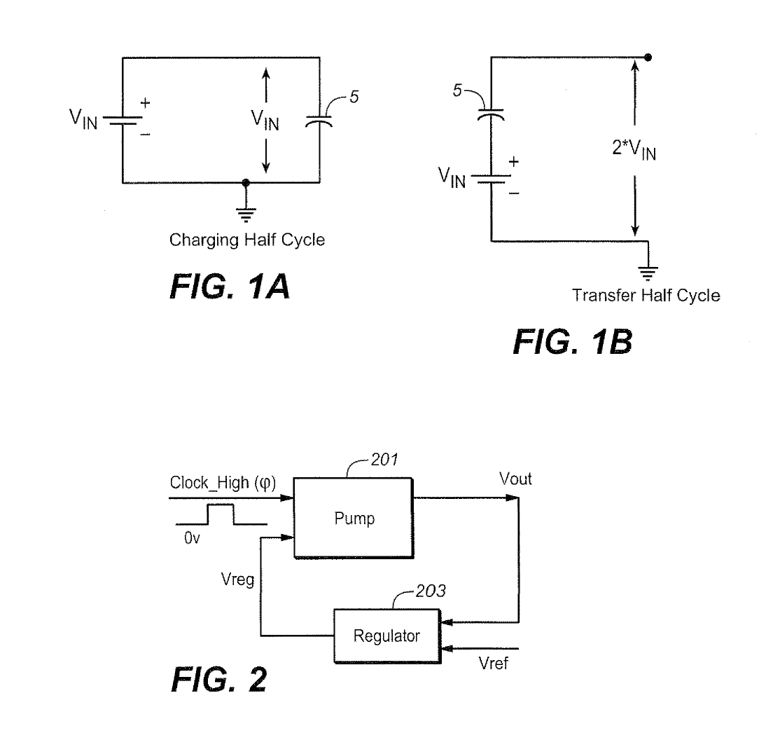

Although the transistors in FIG. 3A are connected to function as diodes, they are not ideal diodes, in the sense that there will be a voltage drop across each of transistors. Between the drain and source of each of these transistors will be a voltage drop. This voltage drop will be the threshold voltage, Vt, of the transistor when there is no current flowing and Vt+ΔVds when there is current, where extra drain-source voltage drop can become proportionately quite large as current increases. Consequently, these voltage drops will reduce the output voltage of a real charge pump below that of the idealized charge pump like that discussed above in the Background with respect to FIG. 1.

Various methods are known to overcome this voltage drops. For example, the number of stages in each branch can be increased to just pump the voltage up higher and the later stages can be used to cancel the threshold voltages. Another example could be a four phase Vt cancellation scheme. However, these prior cancelation techniques have limitations of one sort or another. For example, increases in the number of stages results in increases for both the required layout area and power consumption. Further, as each subsequent transistor in the series is subjected to higher voltages, their respective voltage drops become higher and the incremental gain in each stage correspondingly diminishes. In a four phase Vt cancellation scheme, the clock skews used can be difficult to control due to mismatch and routings.

Instead, the techniques presented here cancel the threshold voltage by introducing a threshold voltage cancellation section that has the same structure as the main section of the charge pump that supplies the output. In the main section, rather than use the transistors connected as diodes, the threshold voltage cancellation stage uses the outputs from the section of the main section that it is mirroring to control the transistors. This will be illustrated using an exemplary embodiment based on a voltage doubler type of charge pump, which has been found to particular for use as an efficient low voltage output charge pump, where, in this example, the goal is to generate a target output of 4 volts from an input voltage of 2.5 volts.

More specifically, with an input voltage of Vcc=2.5 volts, to generate a 4 volt output supply able to deliver 2 mA output current, with minimum input current Icc and area requirements and good power efficiency is challenging. Normally, the sort of Dickson pump of FIG. 3 is the basic architecture for a charge pump; however, for these sorts of values, Dickson pumps have relatively large die size, higher Icc consumption and less efficiency. Normal Vt cancellation schemes are difficult to apply to such architectures. As noted above, these are normally implemented with Dickson pump by pumping to higher than 4 volts in order to meet the design requirement and overcome the higher internal impendence.

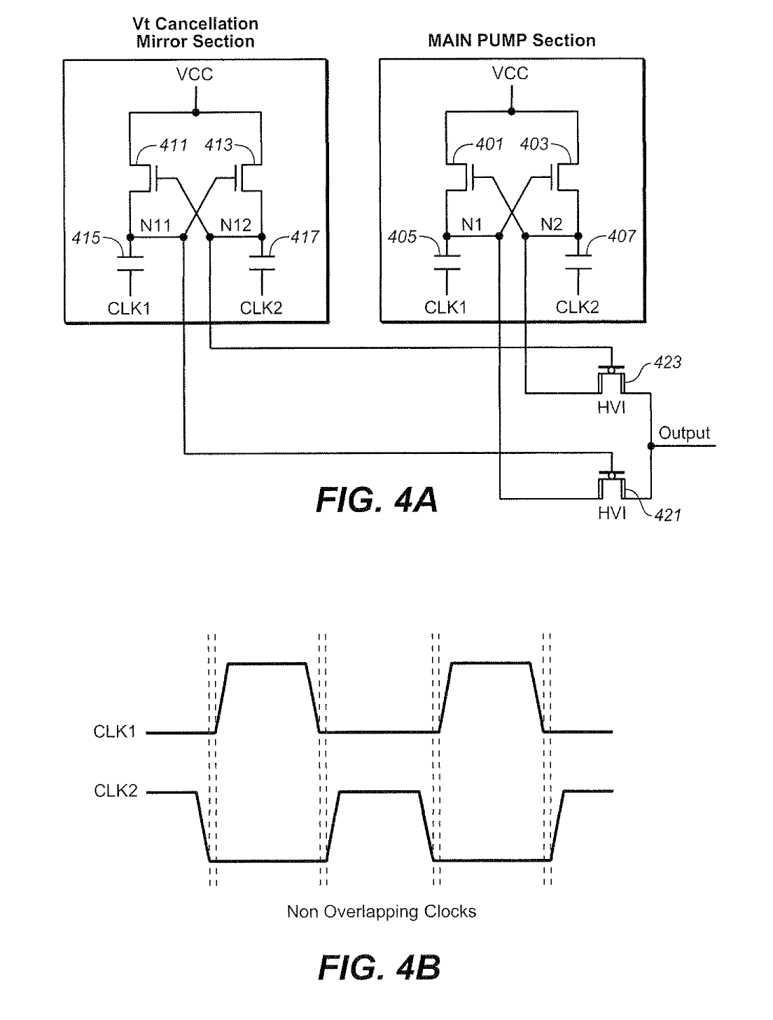

FIG. 4A shows the exemplary embodiment. The main, or output, pump section provides the output to drive the load and has the structure of a voltage doubler the input voltage Vcc is provided to both branches and through transistor 401 to node N1 in the first branch and through transistor 403 to node N2 in the second branch. The control gates of each of these transistors is then attached to receive the voltage on the other branch, with the gate of 403 to node N1 and the gate of 401 to N2. Each of the nodes are also coupled to a capacitor, respectively capacitor 405 driven by the clock signal CLK1 and capacitor 407 driven by the clock signal CLK2. The clock signals are again non-overlapping clocks such as shown in FIG. 4B. The clock signals can be generated in any of the known manners. As the clocks alternate, the output of each branch will alternately (ideally) provide a doubled output voltage from the nodes N1 and N2, which are then combined to form the pump output.

To prevent the charge from flowing back from the output into the pump, the nodes N1 and N2 are respectively connected to the output through transistors 421 and 423. In a typical prior art arrangement, these two transistors would be connected as diodes, having their control gates connected to also receive the voltages on N1 and N2, respectively. However, this would result in the sort of voltage drops described above. Instead, a threshold voltage cancellation section, as shown on the left side of FIG. 4A is introduced to supply the control gate voltages for these output transistors 421 and 423.

The Vt cancellation section has the same structure and the output section and mirrors its function. A first branch includes transistor 411 and capacitor 415 and a second branch includes transistor 413 and capacitor 417, with the control gates of the transistor in each branch cross-coupled to the output node of the other branch. The output of each branch of the threshold cancellation stage is used to drive the output transistor of the corresponding branch in the output section: the node N11 of the cancellation section is used for the control gate voltage of transistor 421 and the node N22 of the cancellation section is used for the control gate voltage of transistor 423. Since the capacitors in the cancellation section are clocked the same as the same element that they mirror in the output section, when the node N1 of the output section is high, the node N11 in the cancellation section will also be high, so that transistor 421 is on and the output voltage passed; N1 and N11 will similarly be low at the same time, so that 421 is turned off to prevent the back flow of charge. The nodes N2, N22 and transistor 423 function similarly.

Although described here for a pump design based on a voltage doubler, this sort of arrangement for the cancellation of threshold can be used charge pump types. More generally, when used with other designs, in addition to the output section, which will be formed with the same architecture as usual, there will also be a voltage threshold cancellation section formed with the same structure. In the main output section, the transistors typically connected as diodes to charge from back flowing will now have their control gates connected to be set to a voltage from the mirrored node in the voltage cancellation section. For example, going back to FIG. 3A, taking the shown Dickson pump as the output section, a voltage cancellation stage of the same structure (less transistors 309 and 319, which take the role of 421 and 423 in FIG. 4A) would also be included. The level on the equivalent of the top plate of 307 on the cancellation stage would control the gate of 309, the level on the equivalent of the top plate of 303 would control the gate of 305, and so on for the other branch.

It should be noted that although the output section and the cancellation section have the same structure, the various mirrored elements of the circuits need not have the same size since the elements of the output stage need to drive the load of the charge pump, whereas those of the cancellation are only driving some control gates. Returning to the exemplary embodiment, the transistors 401 and 403 and capacitors 405 and 407 need provide sufficient output for the application (e.g., 4 volts and 2 mA). In contrast, the transistors 411 and 413 and capacitors 415 and 417 need only provide sufficient output for the control gate voltage of transistors 421 and 423. For example, if the transistors in the cancellation stages need only be sized a tenth or twentieth that of the elements they mirror in the output stage.

Compared with a typical prior art design based upon a Dickson pump, the exemplary embodiment of FIG. 4A has been found to be of higher efficiency for the target values (output of 2 mA at 4V with an input voltage of 2.5V). More specifically, using a voltage doubler for both the main and the Vt cancellation stage yields about twice the efficiency, with 50% less input current (Icc) consumption. Area efficiency is also improve as the doubler type design can provide these values with less stages, yielding an area efficiency requirement of about 40% that of a conventional Dickson pump.

The scheme presented here also has a number of other advantages. Unlike other Vt cancellation techniques, there is no requirement of the main, output section's stages to cancel the Vts, as the cancellation section handles this. There is also no reliance on complex clock phases or skews since the two pump sections operate in phase with each other. Additionally, the use of identical structures for the two sections results in a better and easier layout matching and clock skew matching of the pump clocks. In particular, the simple design and simple layout requirements are a distinct practical advantage.

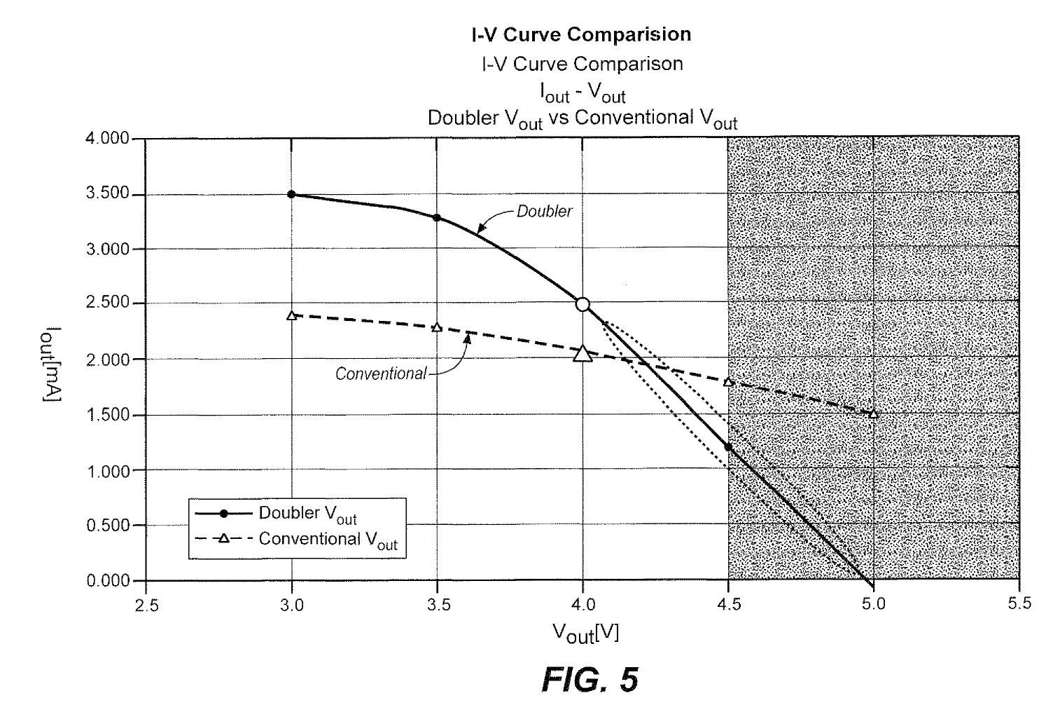

FIGS. 5-7 can help illustrate the efficient of the exemplary embodiment as a low output voltage pump. FIG. 5 shows a comparison of the output I-V curve for the exemplary embodiment versus a conventional pump design. As shown, the doubler can theoretically double the input voltage, here Vcc=2.5, to 5V maximum. The operation region will typically be for voltages of 4.5V or less, as the design is particularly effective between 3V and 4V. For higher outputs from the same input, the design of FIG. 4A can have its number of stages expanded.

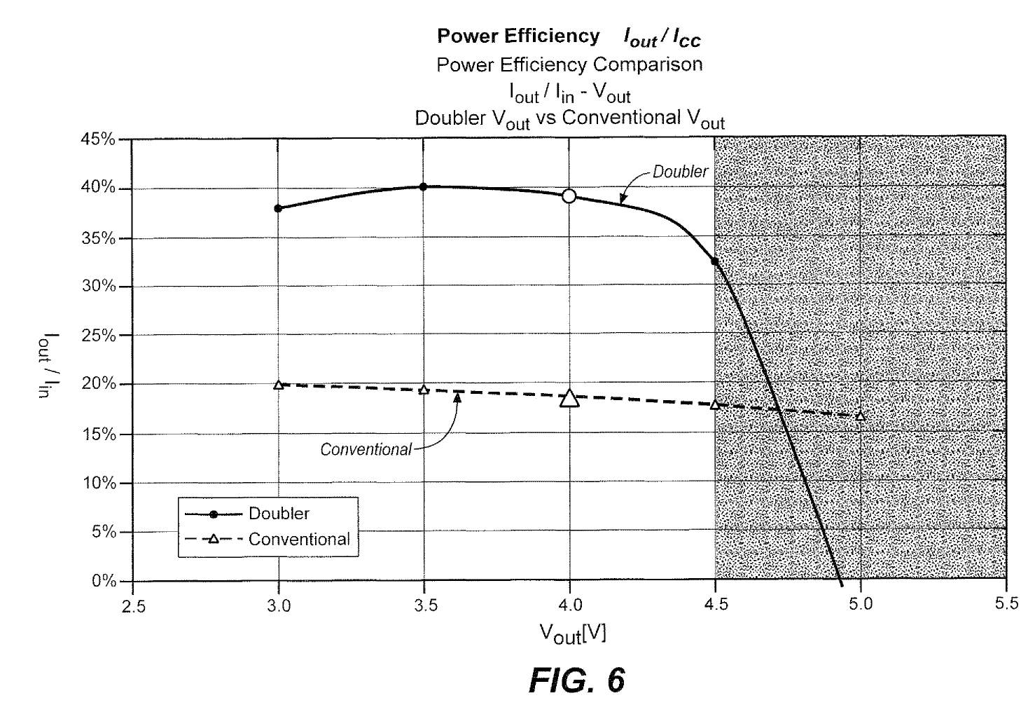

FIG. 6 shows a comparison of the output (Iout/Iin) versus Vout curve for the exemplary embodiment versus a conventional pump design. The power efficiency of the exemplary embodiment is over twice that of a conventional pump at Vout=4V.

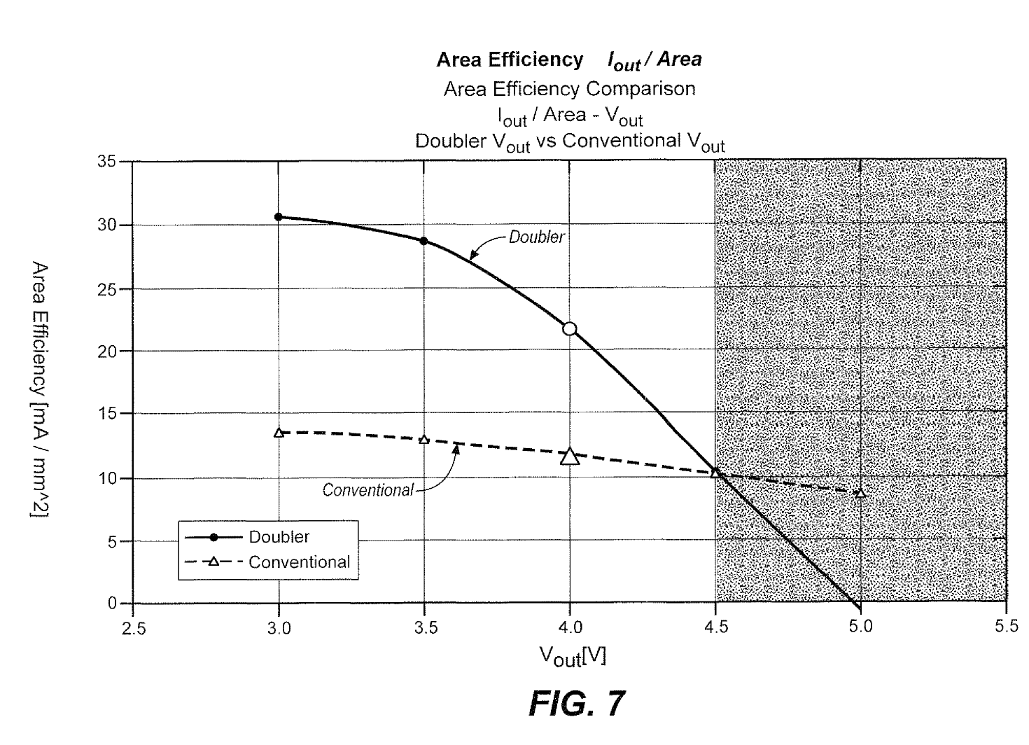

FIG. 7 shows a comparison of the output (Iout/area) versus Vout curve for the exemplary embodiment versus a conventional pump design. The area efficiency of the doubler is about twice that of a conventional pump at Vout=4V, with even better values at lower voltages.

Although the invention has been described with reference to particular embodiments, the description is only an example of the invention's application and should not be taken as a limitation. Consequently, various adaptations and combinations of features of the embodiments disclosed are within the scope of the invention as encompassed by the following claims.

It is claimed:

1. A charge pump circuit to generate an output voltage, including:
an output generation section having a first branch receiving a first clock signal and providing a first output and a second branch receiving a second clock signal and providing a second output, wherein the first and second clock signals are non-overlapping;
a threshold voltage cancellation section having a first branch receiving the first clock signal and providing a first output and a second branch receiving the second clock signal and providing a second output, wherein the first and second clock signals are non-overlapping, wherein the output generation section and the threshold voltage cancellation section have the same structure; and
a first and second transistor, wherein the first and second outputs of the output generation stage are respectively connected through the first and second transistors to provide the output voltage, and wherein the first and second outputs of the threshold voltage cancellation stage are respectively connected to the control gate the first and second transistors.

2. The charge pump circuit of claim 1, wherein the first and second branches of both the output generation section and the threshold cancellation section respectively include a first and a second capacitor, the first clock signal being supplied to a plate of the first capacitor and the second clock signal being supplied to a plate of the second capacitor.

3. The charge pump circuit of claim 1, wherein circuit elements of the output generation section are sized differently than the corresponding elements in the threshold cancelation section.

4. The charge pump circuit of claim 1, wherein said branches have a Dickson pump-type of structure.

5. The charge pump circuit of claim 1, wherein the sections have a voltage doubler-type of structure.

6. The charge pump circuit of claim 5, wherein, for each of said sections, the first branch comprises:
a first transistor connected between an input voltage and a first output node from which the first output is provided, wherein a plate of the first capacitor not connected to receive the first clock signal is connected to the first output node; and
wherein the second branch comprises:
a second transistor connected between the input voltage and a second output node from which the second output is provided, wherein a plate of the second capacitor not connected to receive the second clock signal is connected to the second output node,
wherein the gate of the first transistor is connected to the second output node and the gate of the second transistor is connected to the first output node.

7. The charge pump circuit of claim 6, wherein the first and second transistors of the threshold voltage cancellation section are sized smaller than the first and second transistors of the output generation section.

8. A method of generating an output voltage from an input voltage, comprising:
in a first charge pump section having first and second branches:
receiving the input voltage;
receiving a first clock at the first branch and generating therefrom a first output from the input voltage;
receiving a second clock signal at the second branch and generating therefrom a second output from the input voltage, wherein the first and second clock signals are non-overlapping;
in a second charge pump section having first and second branches, where the first and second charge pump sections have the same structure:
receiving the input voltage;
receiving the first clock at the first branch and generating therefrom a first output from the input voltage;
receiving the second clock signal at the second branch and generating therefrom a second output from the input voltage;
respectively connecting the first and second outputs of the second charge pump section to the control gates of a first transistor and a second transistor; and
respectively connecting the first and second outputs of the first charge pump section through the first and second transistors to provide the output voltage therefrom.

9. The method of claim 8, wherein the first and second branches of both of said charge pump section respectively include a first and a second capacitor, the first clock signal being received at a plate of the first capacitor and the second clock signal being received at a plate of the second capacitor.

10. The method of claim 8, wherein the circuit elements of the first charge pump section are sized differently than the corresponding elements in the second charge pump section.

11. The method of claim 8, wherein said branches have a Dickson pump-type of structure.

12. The method of claim 8, wherein the sections have a voltage doubler-type of structure.

13. The method of claim 12, wherein, for each of said charge pump sections, the first branch comprises a first transistor connected between the input voltage and a first output node from which the first output is provided, wherein a plate of the first capacitor not connected to receive the first clock signal is connected to the first output node; and wherein the second branch comprises a second transistor connected between the input voltage and a second output node from which the second output is provided, wherein a plate of the second capacitor not connected to receive the second clock signal is connected to the second output node, wherein the gate of the first transistor is connected to the second output node and the gate of the second transistor is connected to the first output node.

14. The method of claim 13, wherein the first and second transistors of the second charge pump section are sized smaller than the first and second transistors of the second charge pump section.
